(19) United States
(12) Patent Application Publication
(10) Pub. No.: US 2002/0032622 A1
(43) Pub. Date: Mar. 14, 2002

(54) Shop management method and platform for performing the method

(75) Inventors: Stephane Petit, Herouville (FR); Jean-Paul Dumortier, Putot En Bessin (FR)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: FRANCE TELECOM, Paris (FR)

(21) Appl. No.: 09/948,402

(22) Filed: Sep. 7, 2001

(30) Foreign Application Priority Data
Sep. 8, 2000 (FR) 0011832

(51) Int. Cl. G06F 17/60

(52) U.S. Cl. 705/27

(57) ABSTRACT

A shop management method and a platform for performing the method are provided to assist shopkeepers who have an inventory of products being offered for sale. A management space is assigned for each shopkeeper on the management platform which is remotely located from the shop and is accessible via a network, such as the Internet. Access to the shopkeeper's management space is controlled by authorized list. Certain pre-arranged management tools for this shop are made available to the shopkeeper in the corresponding assigned management space.

### FIELD OF THE INVENTION

The present invention concerns a shop management method utilizing a platform on which management spaces are respectively assigned to a plurality of shopkeepers, each shop containing an inventory of products offered for sale by the shop.

### BACKGROUND OF THE INVENTION

Shopkeepers, also referred to herein as traders, who own relatively small shops frequently possess (1) computer equipment making it possible to be paid by a customer electronically with a bank card, (2) accounting software, and (3) an inventory software and receipts software application. The trader who owns these software items is often quickly confronted with the problem of updating this software. The updating of accounting is essential to conform the software to changes made to the accounting arrangement. The updating of cash receipts is essential to conform the software to the change of payment means, to the change to token money or to the change to cash registers. The updating of inventory software is essential to conform the software to the change of storage place and to the change in packaging. These different software applications are software management tools having the advantage of reducing certain manual tasks, such as the checking of accounts by using an accounting software or the checking of inventory by using an inventory software. However, these software items, especially when used for electronic payments, are most frequently installed on specially designed machines and the trader needs to set up links among these machines. Data is then transferred by using multiple manual entries or with the aid of data files copied onto a floppy disk from one software application and then inputted to a second software application.

### SUMMARY OF THE INVENTION

Accordingly, one object of the present invention is to provide an improved technique for managing a shop belonging to a trader which has an inventory of products being offered for sale.

Another object of the present invention is to enable the trader to effectively manage his shop using software shop management tools, but without licence purchasing and site installation requirements.

Yet another object of the present invention is to enable the trader to effectively manage his shop using software shop management tools, but without needing to update this software.

These and other objects are attained in accordance with one aspect of the invention directed to a method for managing at least one shop belonging to at least one trader and having an inventory of products offered for sale. A management space is provided and assigned to the at least one trader on a management platform remote from the at least one shop belonging thereto and accessible via a network. Access to the management space assigned to the at least one trader is controlled in accordance with an authorization list including a set of identifiers with a set of authentication codes respectively corresponding thereto. Software management tools for managing the trader's at least one shop are made available in the trader's management space.

In accordance with a preferred embodiment, the management tools enable the trader to at least enter and store in his management space his shop's catalog of products and the inventory list for these products, for entering cash register operations and for carrying out accounting operations.

Another aspect of the invention is directed to a shop management platform, operated by a manager, for at least one shop having an inventory list of products being offered for sale, the at least one shop belonging to at least one trader having a contractual arrangement with the manager. At least one server is provided, remote from the at least one shop, and having at least as many management spaces as traders having the contractual arrangement with the manager. The management space of a trader enables access to at least one cash receipts software, one accounting software and one inventory software. Such management space includes a space for storing at least one authorization list, and each management space is protected by an access control comprising the authorization list including a set of identifiers with a set of authentication codes respectively corresponding thereto. At least one input/output port is provided on the platform connected to a network on which the trader is able to connect at least one terminal so as to have access to his management space.

Thus, the method of the invention enables a trader having one or several shops to have available centralized management software items in accordance with a contract entered into with the manager of a management platform on which these software items are installed. To have access to his management space, the trader is connected from a terminal to the platform by means of an Internet type network and is identified and then authenticated. For each management space, the trader specifies an authorization list of authorised users designated by an identifier and a corresponding authentication code.

The method and the platform are able to resolve the problem mentioned above. In fact, the manager makes available in the management space of the trader the software items listed in the contract and attends to the required software licenses and the updating required to be done on behalf of the trader.

The method and platform enable the trader to automatically calculate one day's turnover with details of sales and, on the basis of this calculation, to automatically determine the amount of taxes. The knowledge of this amount advantageously facilitates the tax declarations which need to be regularly made by the trader.

According to a first embodiment, the method and platform further make it possible to display a virtual image of the products that are on sale at the shop, said image being accessible on an Internet site. According to this embodiment, the method further includes the following:

establishing a virtual image of the products that are on sale at the shop of the trader, said image being accessible on an Internet site, and

coordinating the products, displayed as a virtual image, with the catalog and the inventory list of products being sold in the shop, said image and said inventory list being stored in the management space so that the products displayed in the virtual image reflect the products available in the shop.

The platform further includes a means for managing inputs/outputs on the platform, such means for managing being the entrance point for the platform for processing orders made electronically by the customer on an Internet site displaying a virtual image of products available at the shop of the trader.

Thus, a customer is able to make remote purchases by being connected to the Internet site of the shop and by sending an order from the Internet site. This Internet site makes it possible to consult the catalog of products and possibly the catalog of products of other shops belonging to the same trader or of other traders belonging, for example, to a group. This advantageously makes it possible to, firstly, provide the customer with information concerning the list of inventory updated by the trader in his management space and provide said customer with a reliably accurate date of delivery and, secondly to reserve the products ordered for a specific period and then update the list of inventory once delivery has been carried out. The customer is able to obtain the date of delivery of the articles ordered whether said articles are available from existing inventory or whether said articles are covered by a reorder already programmed or one to be programmed.

Synchronizing the customer orders made on the website with the shop data stored in the management space advantageously eliminates the need for the trader to input the order because said order is already recorded via this synchronization with the management space of said trader. Said synchronization further informs the trader that a customer has sent an order from the Internet site. The order issued on the Internet site triggers an alarm on a terminal of the trader, this terminal being connected to the platform by means of a network. The alarm can be in the form of a window which opens and which contains the text of the order, or it may appear in the form of an indicator light which flashes on the screen of the terminal.

According to one variant of the invention, the customer can be put in direct audio or video communication with the trader so as to obtain information. This function is implemented with the displaying of a button saying “Contact the trader” associated with an audio or video circuit installed in the shop. If he wishes to use this option, the customer clicks on the button which activates a call alarm in the shop. The call alarm triggers an audio or video signal depending on the equipment of the trader. In the case of a video signal, which assumes that the point-of-sale of the trader is equipped with a video recorder, the trader appears in a small window of the screen of the customer once he acknowledges the alarm.

According to a second embodiment, the method and platform provide a link between various management spaces belonging to various associated traders forming a group. According to this embodiment, the method further includes:

associating with a group of traders a common management space enabling all the traders of the group to partially see the transactions made by a customer with one of these traders.

By means of this arrangement, the method and platform provide a group with traders a management device for the common management of specific transactions. This common management device is able to implement customer loyalty services, promotional sales services, and group purchasing services on behalf of the group, these services corresponding to particular embodiments of the method. According to one of these embodiments, the method further includes:

crediting a customer with a given amount concerning each transaction carried out with a trader or group of traders, this credit being entered on a loyalty savings account allocated to the customer by the trader or group of traders.

This latter operation can be followed by:

for each cash transaction with a trader, consulting the loyalty savings account with the trader of the customer linked to the cash transaction so as to allocate to him a discount as soon as his loyalty savings account reaches a particular threshold.

According to a third embodiment, the method further includes:

providing a communications and operational link between the management platform and banking establishments so as to allow consultation of one of these banking establishments during a cash transaction using a payment banking product.

According to a fourth embodiment, the method further includes:

on each cash transaction with a trader, updating the inventory list by taking into account the sale of items comprising the cash transaction.

According to a fifth embodiment, the method further includes:

recording an order placed by a customer on the Internet site of a trader,

recording the reference number of the bank product of the customer enabling the order to be paid,

reserving for this customer in the inventory software the items making up his order, and

notifying the trader by means of a computer or paper indicator of an order concluded and to be dealt with on his site.

### BRIEF DESCRIPTION OF THE DRAWINGS

Other characteristics and advantages of the invention will be readily apparent upon a reading of the following description with reference to the accompanying drawings given by way of non-restrictive examples.

FIG. 1 is a flow-chart of a method according to the invention.

FIG. 2 is a diagram of a platform according to the invention and its environment.

### DETAILED DESCRIPTION OF THE PREFERRED EMBODIMENTS

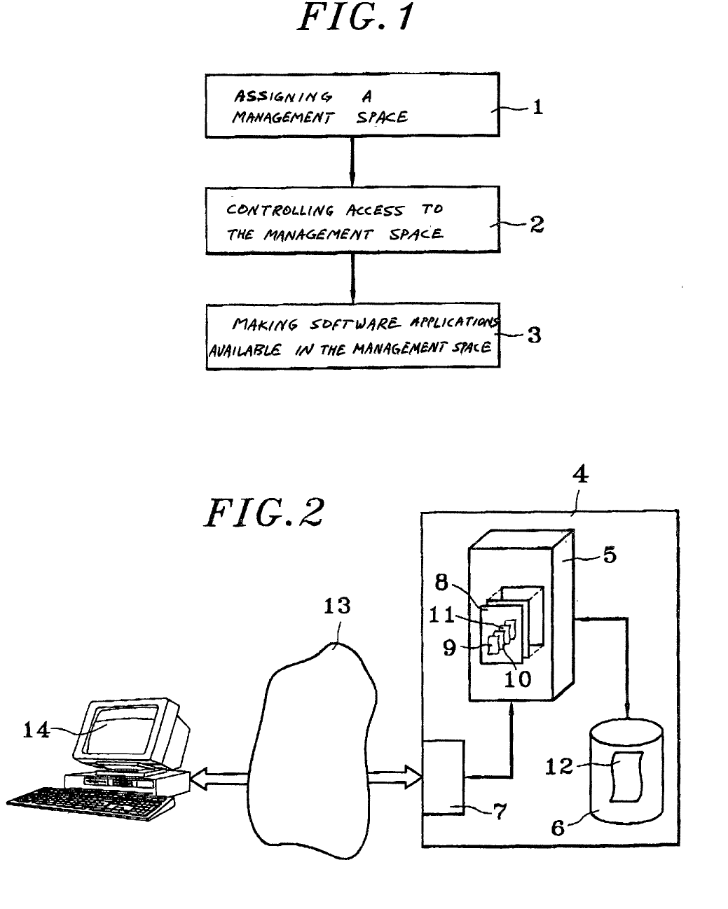

The method of the invention concerns a method for managing shops belonging to at least one trader. Each shop includes inventory of products being offered for sale. The products of the shop are listed in a catalog. For each trader, the method is performed in accordance with operations illustrated in FIG. 1.

In a first operation 1, the method assigns to the trader a management space belonging to him on a management platform remote from his shop, accessible via a network and managed by a manager independent of the trader. The manager can be an individual or an organization such as a company, or unit of a company, that provides the management platform. The assignment of the management space is made in accordance with a contract entered into between the trader and the manager.

In a second operation 2, the method controls access to the management space of the trader by means of a filter which operates based on an authorization list of authorised users comprising at least one authorised user, this list being prepared by the trader in cooperation with the manager.

An authorised user is identified by an identifier, such as his own name or the name of the trader. An authentication code, such as a password, is associated with the identifier. Thus, the user who tries to access the management space needs firstly to be identified by sending an identifier, and secondly to be authenticated by communicating the authentication code associated with his identifier. A trader whose shop includes several cash registers can have a list including as many identifiers as there are cash registers. This same trader can likewise have a list restricted to one identifier, and each cashier is connected to the platform by using the same identifier and the same authentication code. In such a case, the trader is unable to distinguish entries made by any one cashier from those made by the other cashiers.

In a third operation 3, the method makes available the management tools in the management space of the trader. The specific selection of tools depends on the contract concluded between the trader and the manager and includes at least one software for entering and storing a catalog of products and the inventory list of these products, a cash transaction entry software and an accounting software.

FIG. 2 diagrammatically represents a management platform and its environment.

The management platform 4 includes at least one server 5, a storage device 6 and at least one input/output port 7. In addition to this hardware, the platform also includes the necessary software for carrying out the shop management operations and functions described herein. It is deemed unnecessary to describe such hardware and software in detail because they are well known to anyone with ordinary skill in the art.

The server 5 is remote from each shop and comprises at least as many management spaces 8 as there are traders who have entered into a contract with the manager. Each management space 8 comprises an accounting software 9 for the shops of the trader, an inventory software 10 and a cash receipts software 11. The storage device 6 stores a list of authorized users 12 per management space 8. Each management space 8 is protected by an access control comprising the authorization list composed of at least one identifier associated with an authentication code. The storage device 6 is connected to the server 5.

The input/output port 7 is connected to a network 13 on which a trader can connect at least one terminal 14 to access his management space 8. The network 13 is preferably an ADSL type network, the abbreviations standing for Asymmetrical Digital Subscriber Line, or a similar network provided its capacity allow for a permanent connection of the user. This means that at any moment, the user can send a request to the server without having to put up with time delays needed to initiate a connection to the server 5. The terminal 14 can be a point-of-sale terminal (PST) at a fixed station in the shop, or it can be a portable terminal the trader can bring with him and have at his home and be connected from home to the platform by means of a standard cable network of the ADSL type or RNIS (Services Integration Digital Network), a switched telephone type (RTC), a GSM type or of the UMTS type or equivalent. The trader can also undertake to be connected to the platform 4 from any place whatsoever with the aid of a standard GSM or PDA (Personal Digital Assistant) mobile telephone. The input/output port 7 is in liaison with the server 5. According to one preferred embodiment, the input/output port 7 forms a part of the server 5.

When a trader wishes to use the management platform, this takes place as follows. The trader enters into a contract with the manager of the platform. The parties to the contract, namely the trader and the manager, list in the contract the various software applications to be made available to the trader in a management space situated on the platform. The parties also cooperate to determine a list of authorized users who are to have access to this management space. Depending on the organisation of at least his shop, the trader can choose to have one identifier corresponding to all of the cashiers, or, so as to differentiate among the latter, he may select to having as many identifiers for the authorised users as there are cashiers. Furthermore, the trader can choose to have an identifier corresponding to the accountant, this user having privileges of access to the accounting functions.

The list of authorized users depends on the choice of the trader who takes into account firstly the organisation of his shop or shops if he has several, and secondly the hierarchy of authorized accesses to the functions or software.

The trader connects in at least his shop at least one terminal to his management space by means of a network. The network is preferably an ADSL type network. However, when the trader is connected from a site outside his shop, his place of residence for example, he can use another network which provides a link to the platform. This network can to be of the standard cable type, an ADSL type, an RNIS type, an RTC type, a GSM type, an UMTS type or any equivalent type.

When the shop opens for business each day, every cashier establishes a connection via network 13 between his cash register and the shop's management space on the platform. Once this connection is established, the cashier is identified and authenticated by entering his identifier and authentication code. As long as the connection is maintained, the cash transactions entered by the cashier from his cash register are recorded in the management space of the trader. Each recording of a sale triggers an updating of the inventory list and the issuing of a receipt. The cashier's entries can be manual or automatic by means, for example, of a bar code reader scanning the bar code printed on each article. Depending on the equipment of the cash register, the customer can specify the amount of the purchase is to paid with paper money, by check or by electronic payment card.

The processing of a payment by bank card may trigger an interrogation operation whereby the cash register, or terminal, establishes communication with the purchaser's bank, for example, to obtain authorization for the purchase amount of the transaction. This interrogation is controlled by the management space. The response of the bank is sent back to the management space which transmits it to the cash register. According to one embodiment variant, a similar scenario is implemented so as to monitor a check with the server of the National File of Banned Checks or for processing an electronic remittance by setting up and transmitting the image associated with the paper check.

The point-of-sale can readily accept payment by an electronic purse with the aid of the payment card reader. This is another advantage of the present invention in that the protection module of the trader, or SAM (Secured Associated Module), an essential element for protecting payment which is normally installed on the payment terminal, is integrated on the platform in the management space of the trader.

Thus, the management space records the cash transactions, updates the inventory list and informs the accounting software. At the end of the day, the cashier disconnects from the platform and closes his cash register. Then the trader is able to interrogate his management space and immediately knows the results of that day. He can know the status of his inventory, launch orders for restocking, check the accounting information, prepare tax declarations, draw up statistics, etc.

According to one embodiment variant, an alarm procedure with a triggering threshold corresponding to a minimum inventory defined by the trader is activated when the threshold is exceeded. The triggering of the alarm triggers the issuing of an order pre-formatted by the management software on the platform. The transmission of the order to the supplier is immediate and automatic once it has been validated by the trader. The acknowledgement sent back by the supplier specifies the period of time required to re-stock the shop's inventory.

Although specific embodiments of the invention have been described above in detail, various modifications thereto will be readily apparent to anyone with ordinary skill in the art. All such modifications are intended to fall within the scope of the present invention as defined by the following claims.

1. A method for managing at least one shop belonging to at least one trader and having an inventory of products offered for sale, comprising:
providing a management space assigned to said at least one trader on a management platform remote from the at least one shop belonging thereto and accessible via a network,
controlling access to said management space assigned to the at least one trader in accordance with an authorization list including a set of identifiers with a set of authentication codes respectively corresponding thereto, and
making available in the management space of the at least one trader software management tools for managing the at least one shop belonging thereto.

2. Shop management method according to claim 1, further comprising:
establishing a virtual image of the products being offered for sale by the at least one shop of the trader, and making it accessible on an Internet site, and
coordinating the virtual image of the products with the catalog and the inventory list of products stored in the management space so as to have the virtual image reflect the products being offered for sale by the at least one shop of the trader.

3. Shop management method according to claim 1, further comprising:
associating a common management space with a group of traders to give all the traders of the group at least a partial view of the transactions carried out by a customer with one of said group of traders.

4. Shop management method according to claim 3, further comprising:
crediting a customer with a given amount for each transaction carried out with a trader or group of traders, this credit being entered in a loyalty savings account allocated to the customer by the trader or group of traders.

5. Shop management method according to claim 4, further comprising:
for each cash transaction with a trader, consulting the loyalty savings account of the customer with the trader linked to the cash transaction so as to allocate a discount for said customer as soon as said customer's loyalty savings account reaches a specific threshold.

6. Shop management method according to claim 1, further comprising:
providing a communication link between the management platform and banking establishments so as to interrogate one of these banking establishments during a cash transaction implementing a payment banking product.

7. Shop management method according to claim 1, further comprising:
for each cash transaction with a trader, updating the inventory list with an inventory software by taking into account sale of items comprising the cash transaction.

8. Shop management method according to claim 2, further comprising:
recording a order sent by a customer onto the Internet site of a trader,
recording a reference number of the banking product of the customer thus enabling the order to be paid,
reserving in the inventory software for this customer the articles listed in said order, and
alerting the trader with the aid of an indicator of an order sent onto the website of said trader so that the trader can handle said order.

9. Shop management method according to claim 1, wherein said software management tools enable the at least one trader to enter and store in the management space assigned thereto at least a catalog of the products offered for sale, and an inventory list for such products.

10. Shop management method according to claim 1, wherein said software management tools further enable the at least one trader to enter transactions of cash received and to carry out accounting transactions.

11. Shop management method according to claim 1, wherein said management platform is managed by a manager independent of said at least one trader.

12. Shop management method according to claim 1, wherein said products are listed in a catalog stored on the management platform.

13. Shop management method according to claim 1, wherein said set of identifiers with a set of authentication codes respectively corresponding thereto comprises one authorization code for each identifier.

14. Shop management method according to claim 1, wherein said set of identifiers with a set of authentication codes respectively corresponding thereto comprises a plurality of authorization codes for each identifier.

15. A shop management platform, operated by a manager, for at least one shop having an inventory list of products being offered for sale, the at least one shop belonging to at least one trader having a contractual arrangement with the manager, said platform comprising:
at least one server, remote from the at least one shop, and having at least as many management spaces as traders having the contractual arrangement with the manager, said management space of a trader including enablement of access to at least one cash receipts software, one accounting software and one inventory software,
a space for storing at least one authorization list per management space, each management space being protected by an access control comprising said authorization list including a set of identifiers with a set of authentication codes respectively corresponding thereto, and
at least one input/output port on the platform connected to a network on which the trader is able to connect at least one terminal so as to have access to his management space.

16. Shop management platform according to claim 15, further comprising:
at least one input/output managing means on the platform, the managing means being an incoming point for the platform to process orders sent electronically by a customer onto an Internet site showing a virtual image of the products being offered for sale at the shop of a trader.

17. Shop management platform according to claim 15, wherein said management platform is managed by a manager independent of said at least one trader.

18. Shop management platform according to claim 15, wherein said products are listed in a catalog stored on the management platform.

19. Shop management platform according to claim 15, wherein said set of identifiers with a set of authentication codes respectively corresponding thereto comprises one authorization code for each identifier.

20. Shop management platform according to claim 15, wherein said set of identifiers with a set of authentication codes respectively corresponding thereto comprises a plurality of authorization codes for each identifier.

21. Shop management method according to claim 2, further comprising:
associating a common management space with a group of traders to give all the traders of the group at least a partial view of the transactions carried out by a customer with one of said group of traders.

22. Shop management method according to claim 2, further comprising:
providing a communication link between the management platform and banking establishments so as to interrogate one of these banking establishments during a cash transaction implementing a payment banking product.

23. Shop management method according to claim 2, further comprising:
for each cash transaction with a trader, updating the inventory list with an inventory software by taking into account sale of items comprising the cash transaction.
